(19) United States
(12) Patent Application Publication
(10) Pub. No.: US 2014/0136626 A1
(43) Pub. Date: May 15, 2014

(54) Interactive Presentations

(71) Applicant: MICROSOFT CORPORATION, Redmond, WA (US)

(72) Inventors: Jaime Teevan, Bellevue, WA (US); Carlos Garcia Jurado Suarez, Redmond, WA (US); Daniel J. Liebling, Seattle, WA (US); Ann M. Paradiso, Shoreline, WA (US); Curtis N. Von Veh, Redmond, WA (US); Darren F. Gehring, Carnation, WA (US); James F. St. George, Seattle, WA (US); Anthony Carbary, Seattle, WA (US); Gavin Jancke, Seattle, WA (US)

(73) Assignee: MICROSOFT CORPORATION, Redmond, WA (US)

(21) Appl. No.: 13/678,466

(22) Filed: Nov. 15, 2012

(51) Int. Cl. G06F 15/00

(52) U.S. Cl. CPC G06F 15/00
USPC 709/205

(57) ABSTRACT

The description relates to interactive presentation feedback. One example can associate multiple mobile devices with a presentation. This example can receive feedback relating to the presentation from at least some of the mobile devices and aggregate the feedback into a visualization that is configured to be presented in parallel with the presentation. The example can also generate another visualization for an individual mobile device that generated individual feedback.

### BACKGROUND

Smart phones and other mobile devices provide nearly limitless options to users, such as texting, talking on the phone, surfing the web, etc. One downside of these devices is the tendency to isolate the user from their surroundings and what is going on around them. The present concepts can leverage features of these devices to re-engage users with those around them.

### SUMMARY

The described implementations relate to interactive presentations. One example of the present concepts can associate multiple mobile devices, such as smart phones with an interactive presentation. This example can receive feedback relating to the presentation from at least some of the mobile devices and aggregate the feedback into a visualization that is configured to be presented in parallel with the interactive presentation. The example can also generate another visualization for an individual mobile device that generated individual feedback.

Another example can obtain a unique registration for an interactive participation session. This example can receive a request to establish the interactive participation session and allow mobile devices, such as smart phones or pad-type computers, to join the interactive participation session utilizing the unique registration. This example can also correlate feedback from the mobile devices to content from the interactive participation session.

The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the Figure and associated discussion where the reference number is first introduced.

FIGS. 1-11 show example scenarios or systems upon which the present interactive presentation feedback concepts can be employed in accordance with some implementations.

FIGS. 12-13 are flowcharts of examples of interactive presentation feedback methods in accordance with some implementations of the present concepts.

### DETAILED DESCRIPTION

### Overview

This patent relates to mobile devices such as smart phones and/or pad-type computers and reconnecting users with the activities around them in a face-to-face manner. The present concepts allow mobile devices to facilitate user engagement with their current surroundings or context rather than taking users out of their current context. The present concepts can leverage these devices to help people participate more fully in what is going on around them and build stronger ties with their companions. These concepts can also offer the ability to share data between ad-hoc, location-based groups of mobile devices and, as such, can foster rich face-to-face social interactions.

The inventive concepts can provide a real-time interactive participation system designed for use during presentations. For instance, during a meeting, audience members can submit feedback on what has been (or is being) presented using their smart phones. As an example, the users may use a “like” or “dislike” button to rate the presented content. This feedback can then be aggregated and displayed for the audience members and the presenter (e.g., a shared visualization of the feedback). The visualization can be integrated with the presented content or displayed independent of the presented content. The visualization may be presented in multiple ways. For instance, the visualization may be presented to both the presenter and the audience and/or a customized visualization may be generated for individual audience members and/or the presenter.

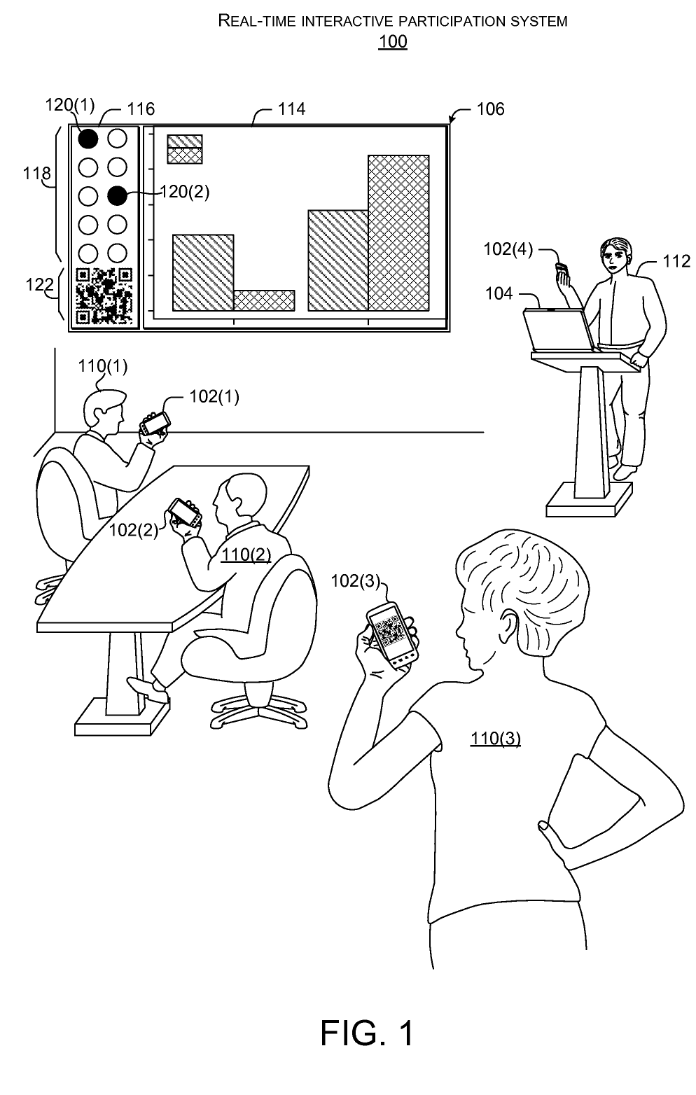

For purposes of explanation, consider introductory FIGS. 1-6 which collectively show a real-time interactive participation environment or “system” 100 in which the present concepts can be employed. In this case, system 100 includes four mobile computing devices manifest as smart phones 102(1), 102(2), 102(3), and 102(4). System 100 also includes a notebook computing device 104 and a display 106. In this case, smart phones 102(1), 102(2), and 102(3) are associated with audience members 110(1), 110(2), and 110(3), respectively. Smart phone 102(4) and the notebook computing device 104 are associated with a presenter 112.

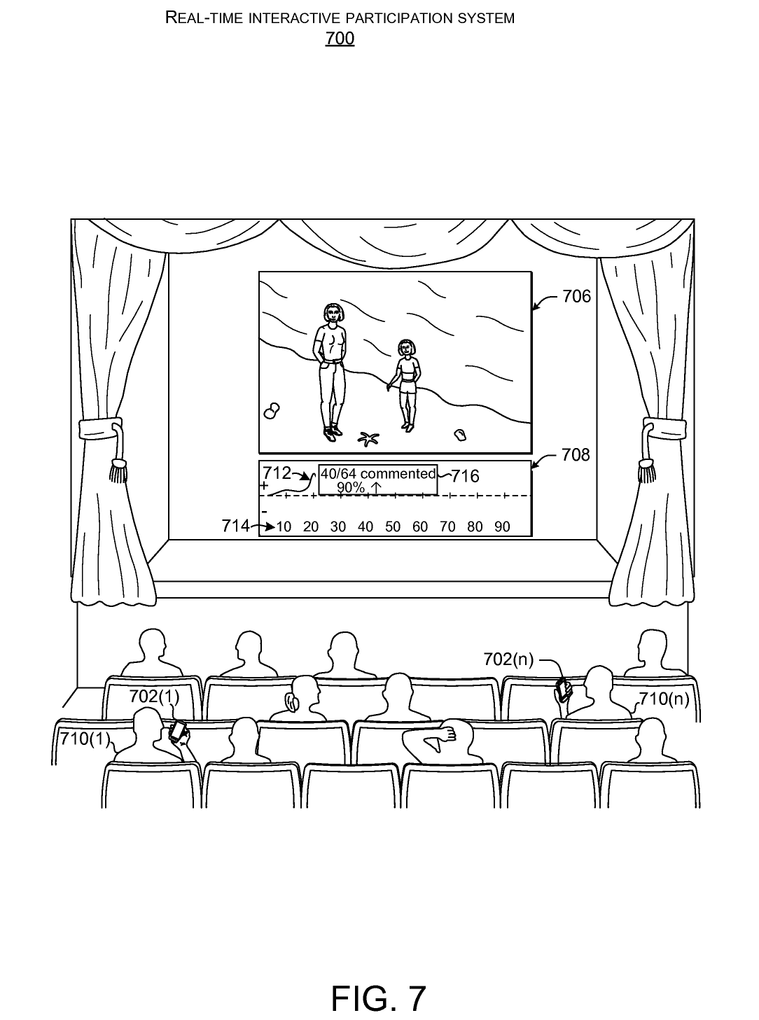

Presenter 112 can utilize notebook computing device 104 to make a presentation that includes visual material represented on a first portion 114 of display 106. A second portion 116 of the display 106 can relate to real-time interactive participation. In this case, the first portion 114 relating to the presentation is separate and distinct from the second portion 116 relating to the real-time interactive feedback, but both portions are presented on display 106. In other cases, the portions 114 and 116 can be intermingled. For instance, comments about a particular aspect of a slide may be visualized proximate to or with that particular aspect. As mentioned above, in this case the two portions 114 and 116 co-occur on the same display 106. Such need not be the case. An alternative example is shown relative to FIGS. 7-9.

In the present example of FIG. 1, second portion 116 relating to the real-time interactive participation includes a feature 118 for identifying participating audience members. In this case the feature for identifying participation is manifest as a set of circles. Individual circles can represent individual audience members. In the present implementation, darkened circles can represent participants (e.g., participating audience members). In the illustrated instance, circle 120(1) represents audience member 110(1) and circle 120(2) represents audience member 110(2). Of course, circles are used here for purposes of explanation, but the feature could be achieved with other characters, shapes, coloring, etc.

In this implementation, the second portion 116 also includes a feature 122 for allowing audience members to join the presentation. In this case, this feature is represented as a QR code. Other implementations can utilize other types of codes, universal resources identifiers (URIs), links, etc. For example feature 122 could include a URI that the audience member manually enters into his/her smart phone to become a participant.

For purposes of explanation, assume that audience member 110(3) has just entered the room to view the presentation. At this point, audience members 110(1) and 110(2) are represented on feature 118 as darkened circles 120(1) and 120(2), respectively. Audience member 110(3) can become a participant by taking a picture of the QR code with her smart phone 102(3). This act can automatically log the audience member into the presentation (e.g., register the audience member) without any other effort on the part of the user (e.g., audience member). Note that while not shown, personal information concerns of the audience members can be addressed when implementing the present concepts. For instance, the audience members can be allowed to opt out, opt in, and/or otherwise define and/or limit how their personal information is used and/or shared. Any known (or yet to be developed) safeguards can be implemented to protect the privacy of participating audience members.

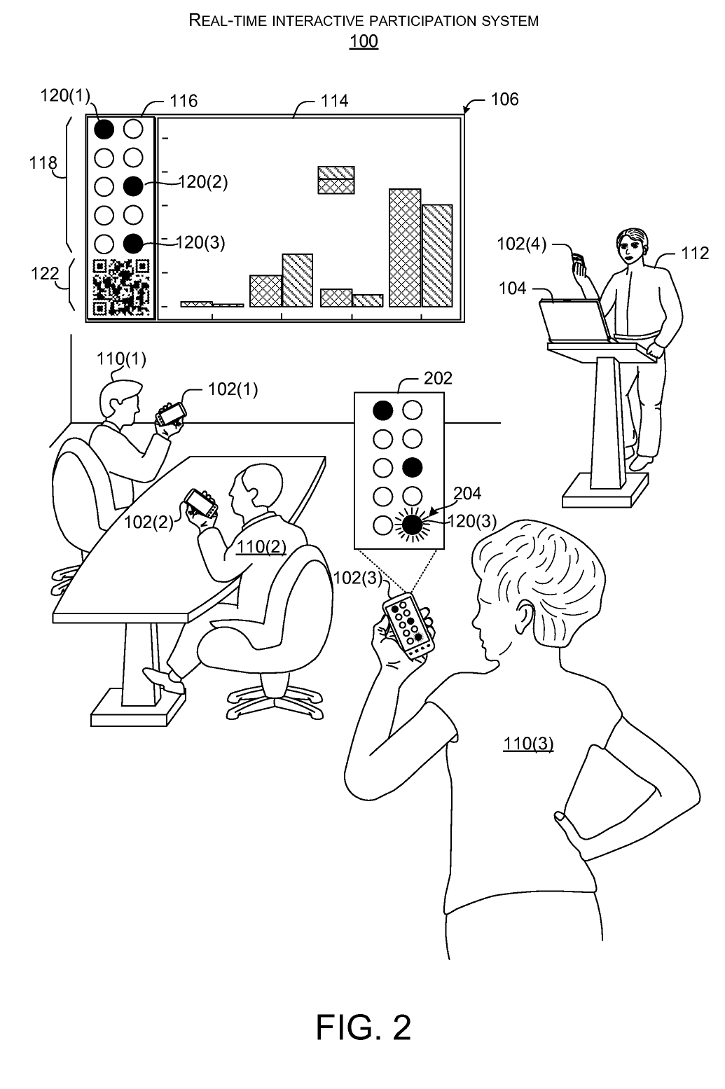

FIG. 2 shows a subsequent view of system 100. In this view, audience member 110(3) has automatically joined the presentation by entering the QR code of FIG. 1. Audience member 110(3) (e.g., her smart phone 102(3)) is now represented on feature 118 as darkened circle 120(3). Further, the audience member can readily determine which circle represents her. In this case, feature 118 is recreated on the audience member's smart phone with her circle distinguished for her. (This view also shows an enlarged view 202 of the screen of smart phone 102(3) to aid the reader). In this case, circle 120(3) is blinking on her smart phone as indicated by starburst effect 204. Of course, there are other ways that the user's circle can be identified to the user. For instance, the circle could be shown with a number or character on feature 118 and that number could also be displayed on the audience member's smart phone. Thus, each audience member's smart phone would display the number or character assigned to them while the feature 118 on display 106 showed all of the numbers.

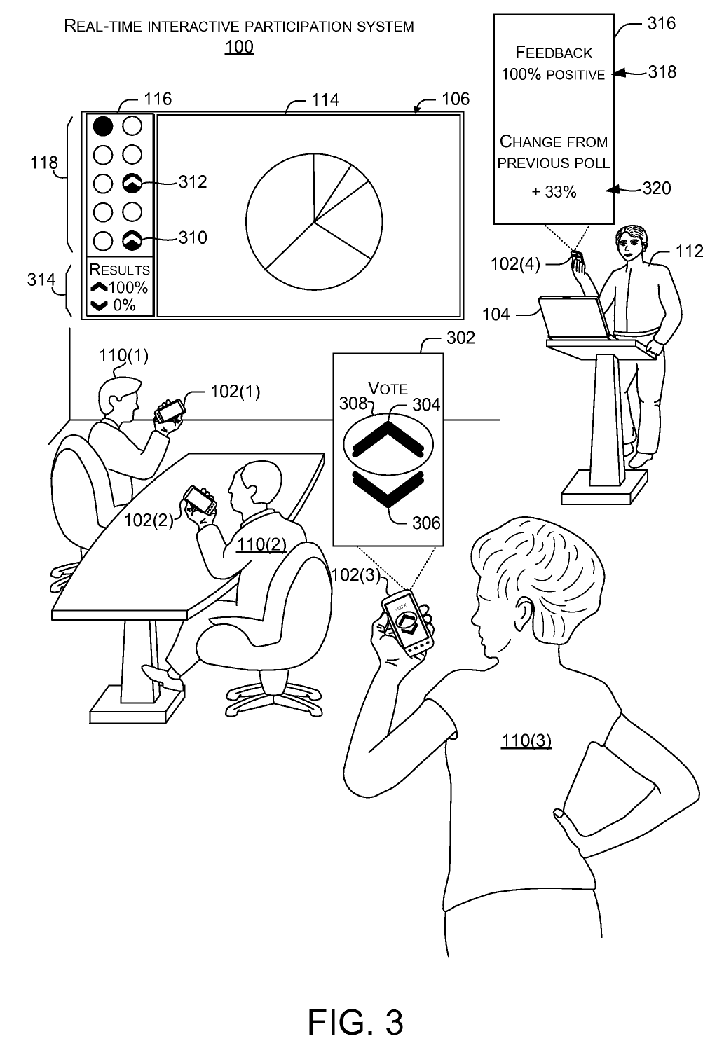

FIG. 3 shows a subsequent view of system 100 where audience members can make comments about the presentation. The audience members can make the comments with their smart phones. For instance, audience member 110(3) is voting on a graphical user interface (GUI) presented on her smart phone 102(3). The GUI can be readily seen in enlarged view 302. In this case, the GUI offers two options: an up or like option 304; and a down or dislike option 306. Of course other implementations can offer more options. For instance, a similar display can be generated to allow the user to answer other formats of interaction. For example, the GUI could be generated responsive to the presenter 112 asking a question, such as a multiple choice question. Thus, the interaction can be audience member initiated or presenter initiated.

In this example, assume that audience member 110(3) selected the ‘like’ option 304 as indicated at 308. This selection is also identified on feature 118 as indicated at 310. Further, audience member 110(2)'s selection is evidenced at 312. Of course, the use of an ‘up arrow’ is only one way that the user input can be represented. For instance, color can be utilized. For example, green could be utilized to represent a ‘like’ or favorable response and red could be used to represent a ‘dislike’ or unfavorable response. Thus, when an individual audience member provides feedback, their character (in this case circle) on the feature 118 could be turned either green or red. Further, the time since voting can be represented on the feature 118. For instance, as time lapses after the audience member votes, the character (e.g., circle) could fade back to its original color, such as yellow. Similarly, in the illustrated configuration, the ‘up arrow’ or ‘down arrow’ could fade from view as the vote becomes stale. In an alternative implementation, the vote could be removed after a predefined duration. For instance, the vote (e.g., the up or down arrow) could be removed after 10 seconds.

Note that while a GUI 302 enables voting via the smart phone's touch screen, other implementations do not rely on the touch screen. For instance a user ‘like’ vote could be recorded if the user raises the smart phone, tips it upward, or places it face up, among others. Similarly, a dislike could be registered when the user lowers the smart phone, tips it downward, or places it face down, among others.

FIG. 3 also introduces a results feature 314. The results feature can reflect the cumulative results from the various participating audience members. In this example, the results represent that the two voting audience members 110(2) and 110(3) both voted favorably (e.g., 100%) and no audience members (e.g., 0%) voted negatively. The results feature 314 can be manifest in various ways. For instance, the results feature may also convey what percentage of audience members voted. The present implementations can allow the results features to be updated in real-time with little or no delay from voting to the votes being reflected on the results feature.

FIG. 3 further introduces a GUI 316 (shown enlarged) that can be generated on the presenter's smart phone 102(4). GUI 316 can convey the same information conveyed on the portion 116. However, in this case GUI 316 is customized for the presenter 112. For instance, in this case, at 318 the GUI shows the present feedback is 100% positive. Also, at 320 the GUI shows the change from the previous poll (e.g., voting instance) is a positive 33% rise in approval.

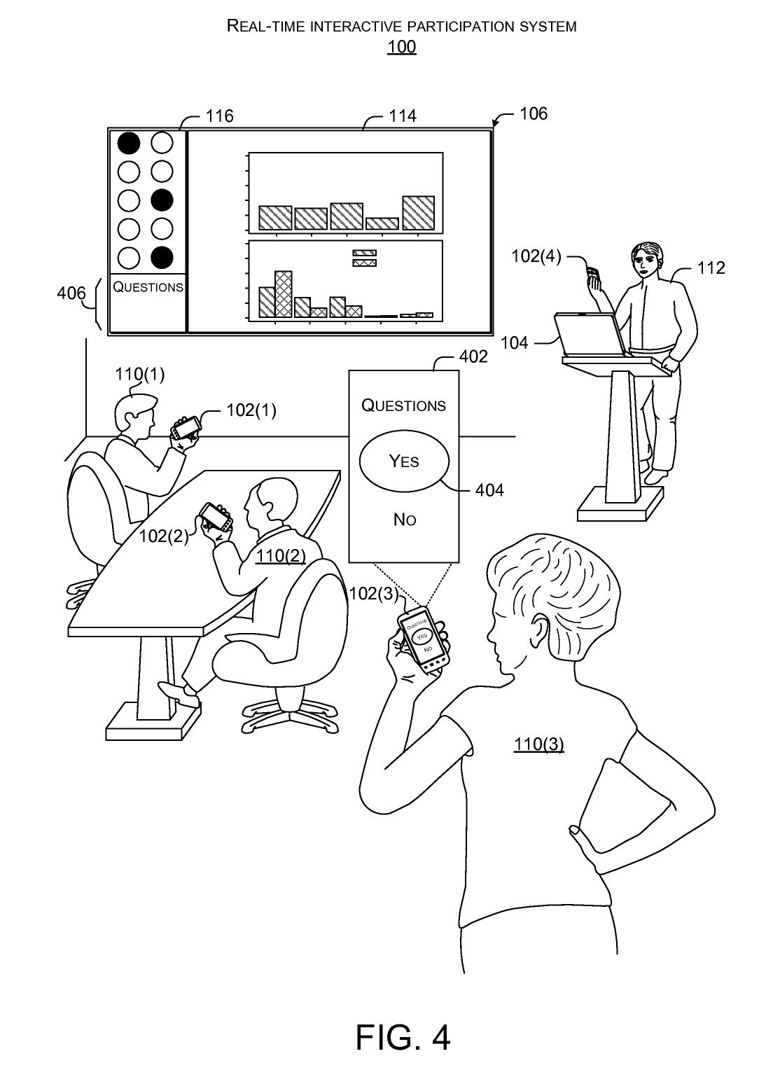

FIG. 4 illustrates example techniques for allowing users to ask questions about the presentation associated with system 100. In this case, the presenter can cause a GUI 402 to be presented on the audience members' smart phones soliciting comments. In other cases, the audience members may initiate the questions. In the illustrated configuration, assume that audience member 110(3) selects ‘yes’ at 404 (indicating that she has a question). In some implementations the user can then type the question. In other implementations, the user can instead speak the question into the smart phone. In some implementations, the spoken question can be converted to text using voice recognition techniques. The text version of the question can be presented on a questions feature 406 of portion 116 and/or on the presenter's smart phone 102(4) and/or notebook computer 104.

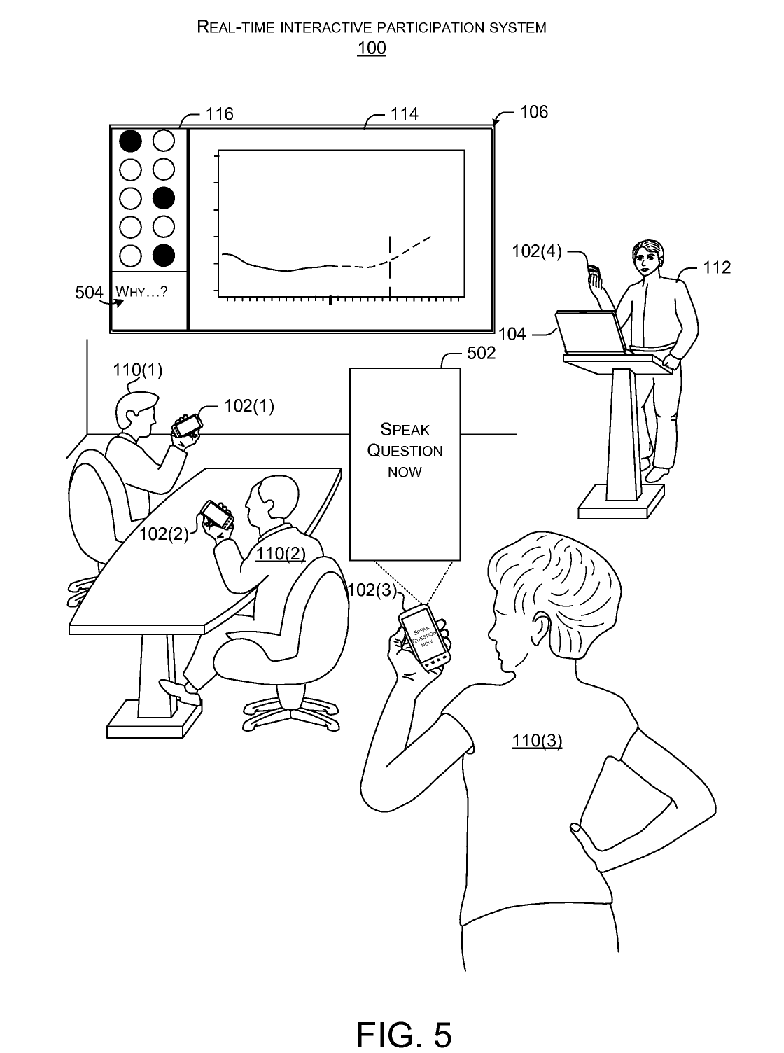

In an alternative scenario illustrated in FIG. 5, the selection of ‘yes’ at 404 (FIG. 4) can cause the individual audience member to be entered into a queue that is displayed for the presenter (e.g., question 1 is from audience member 110(3)). When the presenter 112 selects the audience member from the queue the audience member's smart phone can be automatically activated to function as a microphone as indicated at 502. For instance, the smart phone may vibrate and display the message ‘please ask your question now’. The audience member 110(3) can speak the question into the smart phone 102(3) and the voice signal can be broadcast over the system's speaker system (not shown) so that the other audience members and the presenter can hear the question. This feature is much more convenient than existing scenarios where the presentation has to stop while someone locates the audience member and carries a microphone over to them. At this point the question may also be converted to text and displayed on portion 116 as indicated at 504.

In other implementations the audience member can raise their hand while holding the smart phone to ask a question. This hand raising gesture can be detected by the smart phone which can then provide notice to the presenter 112 (e.g., the presenter's smart phone 102(4)) that an audience member has a question. The notice can be generic or specific. For instance, the notice can appear on the presenter's smart phone 102(4) and/or notebook computing device 104. The notice may include identifying the character (e.g., circle) associated with the audience member asking the question. The question may also provide a stimulus to the presenter to let the presenter know that a question has been received. For instance, the presenter's smart phone may vibrate and/or beep to get the presenter's attention.

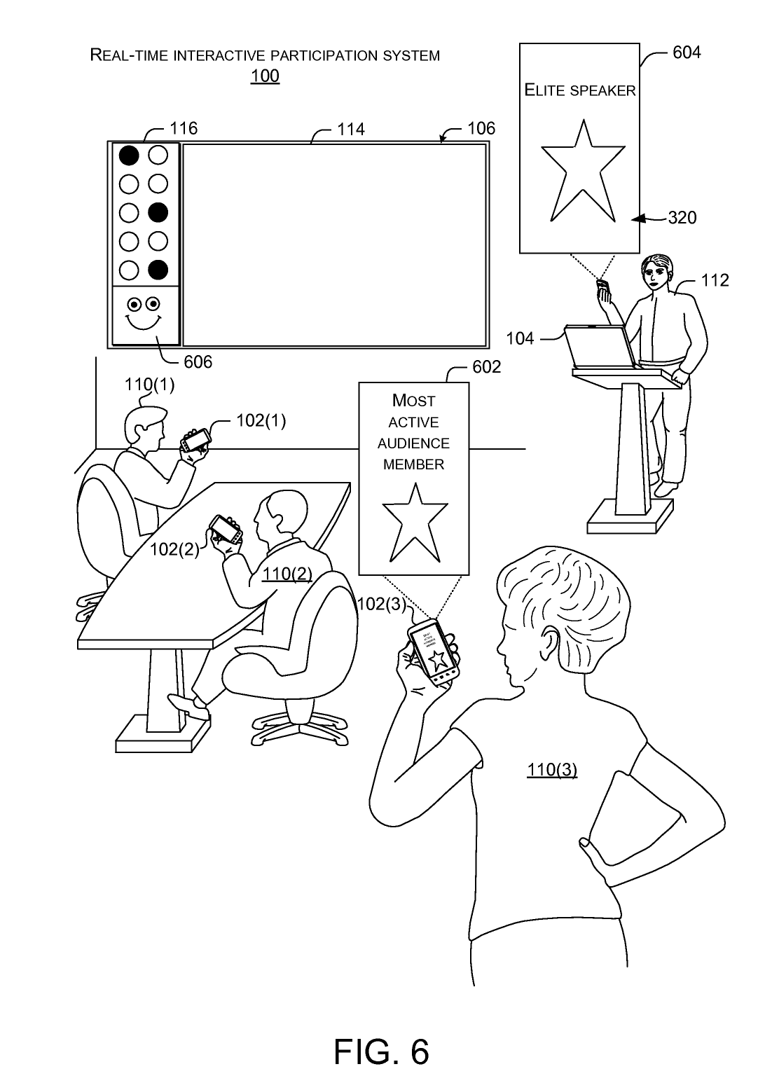

FIG. 6 shows another feature of system 100. In this case, GUI badges are generated for individual users to reflect their contribution. In this case, a ‘most active audience’ member badge 602 is displayed for audience member 110(3) on her smart phone 102(3). Similarly, an ‘elite speaker’ badge 604 is displayed for the presenter 112 on his smart phone 102(4). These badges may or may not be illustrated on portion 116 so that the other users can see them. Badges can be generated utilizing various techniques. In some cases, the badges can summarize occurrences during the presentation. In other cases, the badges can be generated by comparing feedback to a predefined threshold. For instance, the ‘elite speaker badge’ could be set at a 90% positive feedback threshold. Only presenters that get 90% or higher positive feedback would receive the ‘elite speaker’ badge. Note that badges are often visual, but such need not be the case. Badges and/or any of the interactive concepts described herein can alternatively or additionally be presented in other manners, such as in an audible or tactile manner, among others.

Badges can also apply to the entire group, and not just an individual. For example, when many audience members provide feedback, an ‘active audience’ badge may trigger. Group badges may represent presentation events like the amount of feedback activity, the quality of the activity, the number of participants, or the length of the presentation. These group badges may be displayed on audience members' smart phones, or elsewhere (e.g., as part of a shared visualization of the feedback). One such example is shown at 606 in second portion 116 of display 106. In this example, a ‘happy face’ is used to indicate an active positive audience.

In summary, one goal of the present concepts is to create a sense of community among meeting attendees, engage audience members in the presentation, and help the presenter (e.g., speaker) understand the audience reaction. The above description explains an implementation for accomplishing this goal.

FIGS. 7-9 relate to another real-time interactive participation system 700. System 700 illustrates smart phones 702(1) and 702(n) (the suffix “n” indicating that any number of audience members and smart phones or other devices can be accommodated). The system also includes two display devices 706 and 708. Display device 706 is dedicated to presenting content, such as audio and video content. In other implementations, the content could be exclusively audio or exclusively visual. In this example the content is a movie. Display device 708 can be dedicated to (or at least distinct from display device 706). In this case, display device 708 is dedicated to providing real-time interactive participation relative to the content of display device 706.

Audience members 710(1) and 710(n) can participate utilizing techniques described above relative to FIGS. 1-6. For instance, a URI or code could be displayed before the start of the movie on either or both of display devices 706 and 708. The audience members can enter the URI or the code to participate. The audience member can then provide feedback about the content on their smart phones 702(1) and 702(n).

In this implementation, display device 708 can provide a running record of audience feedback at 712. The running record can be displayed in a way that correlates it to the movie content as represented by the time(s) in minutes indicated generally at 714. For instance, when feedback is received at a particular point in the movie (e.g., at a particular temporal instance) the feedback can be time stamped with that particular temporal instance to provide easy correlation between the feedback and the movie.

At particular instances, display device 708 can provide additional information relating to the audience feedback. One such example is shown in FIG. 7 where a spike in audience feedback occurs at 20 minutes into the movie. In this case, the additional information 716 is manifest as a text box that overlays some of the audience feedback 712. The additional information 716 indicates that 40 out of 64 participating audience members provided feedback and that 90% of that feedback is positive (e.g., ↑).

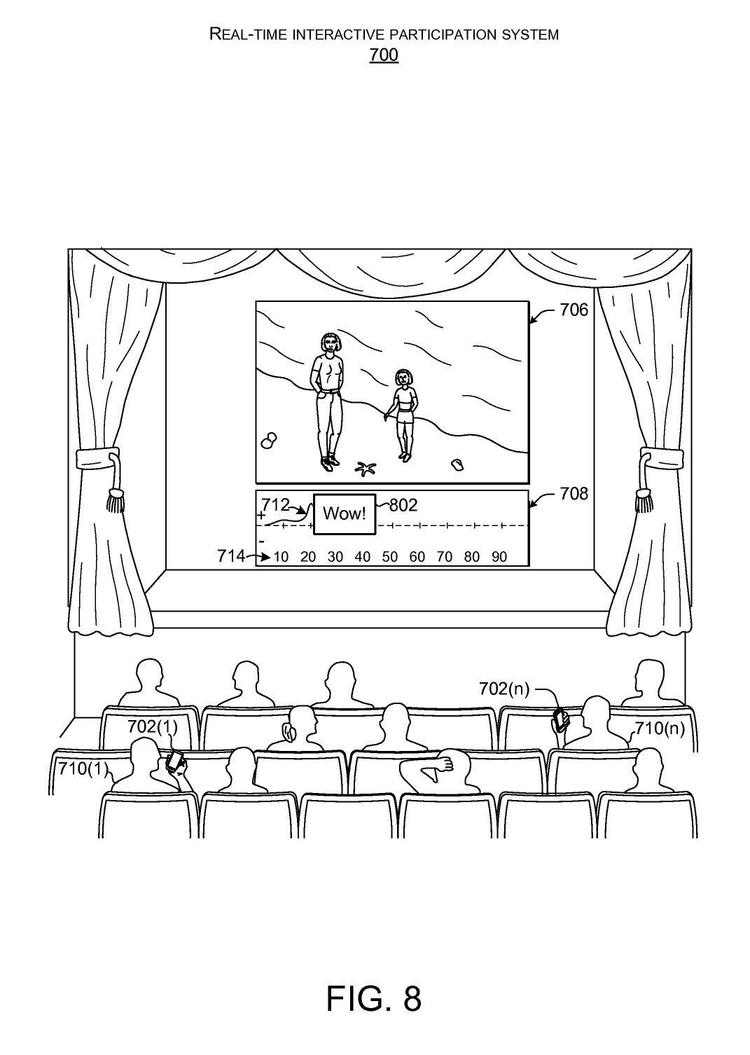

FIG. 8 shows another instance of additional information in a more analyzed form. In this case, the spike in audience feedback and the relative percentage of positive feedback was processed by an algorithm that generated a “Wow!” characterization of the feedback in the form of a badge 802.

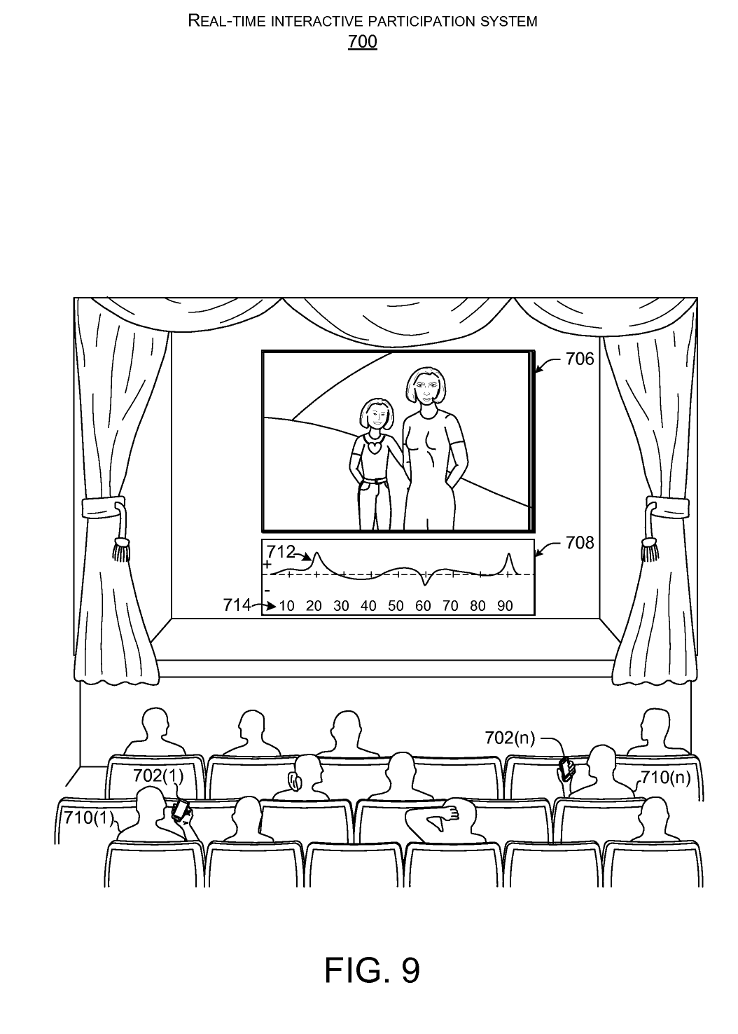

FIG. 9 shows system 700 at the end of the movie. Note that display device 708 shows how much audience feedback was received at each point in the movie via the running record of audience feedback at 712 and the run times at 714. Either immediately following the movie, or at a later time, a user can use this information to review specific points in the movie that are of interest according to the audience feedback. For instance, the previously discussed positive spike in feedback at 20 minutes, a spike in negative feedback at 60 minutes, and another positive spike at 90 minutes can convey which points in the movie were of most interest to the audience members. The user could then use the audience feedback in various ways. For instance the user may want to watch just those portions of the movie, or maybe the movie was a preview and the user is an editor who might want to edit the movie based upon the audience feedback.

In summary, the feedback collected during presentation of content, such as a meeting or a movie can also be used after the meeting to retrieve or summarize meeting content (e.g., individual slides from a larger slide deck, portions of a transcript, segments of a video, etc.). Meetings typically last for 30 minutes to many hours. There are a variety of reasons why a person would like to review the important content of a meeting without replaying the entire meeting. For example, the person might not have been able to attend or may want to prepare a written summary. Existing approaches include analyzing audio and video recordings of meetings via signal processing to determine key points in time, synchronizing with slide decks, etc. However, these methods use either inferred sentiment or sentiment-agnostic techniques that may generate many false positive “important” moments. In contrast the present implementations can obtain and aggregate attendee feedback and correlate that feedback to the content so that a subsequent user can utilize the comments as a guide to points of interest in the content.

Stated another way, the above discussion can provide the ability to view feedback over time, to associate or correlate feedback events with meeting artifacts such as slides, transcripts, or video recordings, and to use the feedback to summarize meeting artifacts.

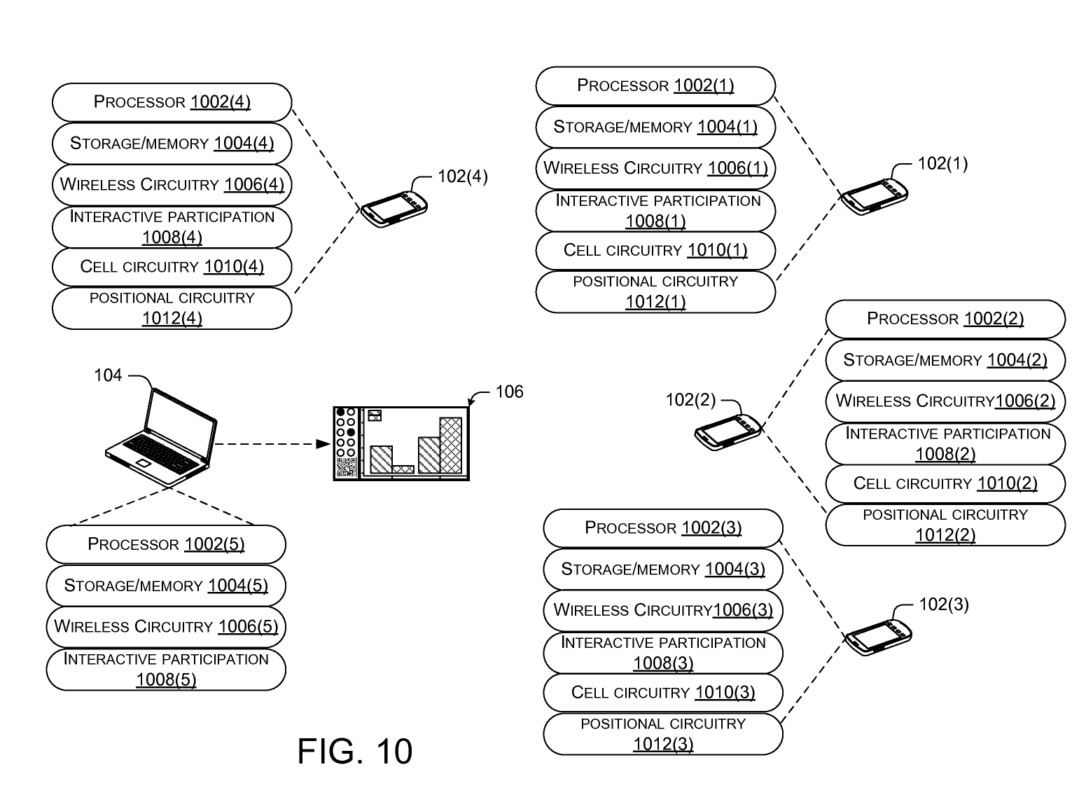

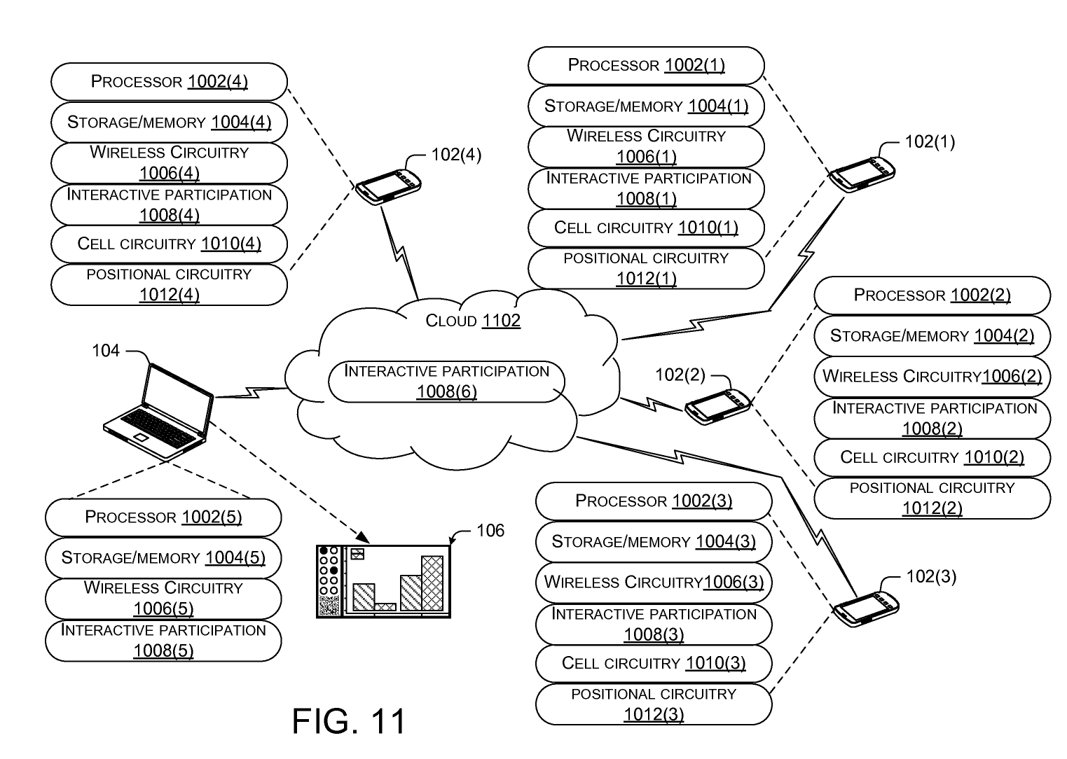

FIG. 10 shows the devices of system 100 enabled in accordance with one implementation. FIG. 10 illustrates some of the elements or components that may be included in such devices. An alternative implementation is described relative to FIG. 11.

In this case, display 106 can be a monitor, TV, or projector that is coupled to notebook computing device 104 and is not described further. However, in some implementations the display could be a smart device with some or all of the capabilities described below.

In the present configuration each of the smart phones 102(1)-102(4) can include a processor 1002, storage/memory 1004, an interactive participation component 1008, wireless circuitry 1006, cell circuitry 1010, and positional circuitry 1012. Further, notebook computing device 104 also includes a processor 1002, storage/memory 1004, an interactive participation component 1008, and wireless circuitry 1006. Suffixes (e.g., (1), (2), (3), (4), or (5)) are used to reference a specific instance of these elements on specific respective smart phones or the notebook computing device. Use of these designators without a suffix is intended to be generic. The discussed elements are introduced relative to particular implementations and are not intended to be essential. Of course, individual devices can include alternative or additional components that are not described here for sake of brevity. For instance, devices can include input/output elements, buses, graphics cards, power supplies, optical readers, and/or USB ports, among a myriad of potential configurations.

Smart phones 102(1)-102(4) and notebook computing device 104 can be thought of as computers or computing devices. Examples of computing devices can alternatively or additionally include traditional computing devices, such as personal computers, cell phones, mobile devices, personal digital assistants, pad-type computers, cameras, or any of a myriad of ever-evolving or yet to be developed types of computing devices.

Computing devices can be defined as any type of device that has some amount of processing capability and/or storage capability. Processing capability can be provided by processor 1002 that can execute data in the form of computer-readable instructions to provide a functionality. Data, such as computer-readable instructions, can be stored on storage/memory 1004. The storage/memory can be internal and/or external to the computer.

The storage/memory 1004 can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media can include “computer-readable storage devices.” Examples of computer-readable storage devices include volatile storage media, such as RAM, and non-volatile storage media, such as hard drives, optical discs, and flash memory, among others.

In the illustrated implementation, computing devices are configured with general purpose processors and storage/memory. In some configurations, such devices can include a system on a chip (SOC) type design. In such a case, functionalities can be integrated on a single SOC or multiple coupled SOCs. In one such example, the computing devices can include shared resources and dedicated resources. An interface(s) can facilitate communication between the shared resources and the dedicated resources. As the name implies, dedicated resources can be thought of as including individual portions that are dedicated to achieving specific functionalities. For instance, in this example, the dedicated resources can include any of the wireless circuitry 1006 and/or the interactive participation component 1008.

Shared resources can be storage, processing units, etc. that can be used by multiple functionalities. In this example, the shared resources can include the processor and/or storage/memory. In one case, interactive participation component 1008 can be implemented as dedicated resources. In other configurations, this component can be implemented on the shared resources and/or the processor can be implemented on the dedicated resources.

Wireless circuitry 1006 can include a transmitter and/or a receiver that can function cooperatively to transmit and receive data at various frequencies in the RF spectrum. The wireless circuitry can also operate according to various wireless protocols, such as Bluetooth, Wi-Fi, etc. to facilitate communication between devices.

In one case, the notebook computing device's wireless circuitry 1006(5) can function as a Wi-Fi group leader relative to the smart phone devices 102(1)-102(4) to facilitate the interactive feedback. In other cases, the notebook computing device may work in cooperation with the presenter's smart phone 102(4) which can facilitate communications among the various devices to facilitate the interactive feedback.

Cell circuitry 1010 can be thought of as a subset of wireless circuitry 1006. The cell circuitry can allow the smart phones 102 to access cellular networks. The cellular networks may be utilized for communication between devices and/or the cloud as described above.

Positional circuitry 1012 can be any type of mechanism that can detect or determine relative position, orientation, movement, and/or acceleration of the smart phone device 102. For instance, positional circuitry can be implemented as one or more gyroscopes, accelerometers, and/or magnetometers. In one example, these devices can be manifest as microelectromechanical systems (MEMS). Examples of techniques that utilize the positional circuitry are described above relative to FIGS. 2 and 5 where relative position, orientation, or movement of the smart phone are detected and processed to determine the intended user feedback.

Interactive participation component 1008 can allow audience members and/or a presenter to share ideas and thoughts in real-time. The interactive participation component 1008 can operate cooperatively with the wireless circuitry 1006 to facilitate communication between the various devices.

Briefly, in some implementations the interactive participation component 1008 can be configured to receive audience feedback during a presentation and to aggregate the feedback. In some cases the interactive participation component can send a summary of the aggregated feedback to a first device for display concurrently with the presentation and send the summary to a presenter's smart phone during the presentation.

In some cases, the interactive participation components 1008 employed in a system can each be fully functioning, robust components. In other configurations, an instance of the interactive participation component 1008 associated with the presenter may be robust, while those associated with the audience members may offer a more limited functionality. For example, in the illustrated configuration, an instance of the interactive participation component 1008(1) or 1008(2) on the presenter's notebook computing device 104 and/or smart phone 102(4), respectively, may function in a ‘lead’ role that registers audience members' smart phones 102(1)-102(3). This lead interactive participation component can transmit questions to the audience members' smart phones. The lead interactive participation component can receive feedback from the audience members' smart phones and aggregate and/or otherwise process the feedback.

The lead interactive participation component 1008(1) or 1008(2) can present the aggregated feedback adjacent to the presenter's content via a second portion of the display (e.g., sidebar), within the content or on a separate device from the content. The lead interactive participation component can employ algorithms to generate badges when there are interesting feedback events. The lead interactive participation component can then send the badge to the corresponding smart phone. The lead interactive participation component may cause the smart phone to vibrate or otherwise notify the user of the badge. An alternative configuration is described below relative to FIG. 11.

FIG. 11 shows an alternative implementation to the relatively ‘device specific’ implementation of FIG. 10. In this case, the notebook computer 104 and smart phones 102(1)-102(4) communicate with the cloud (e.g., cloud-based resources) 1102 over a network. The cloud can include another instance of the interactive participation component (designated as 1008(6)). In this example, most of the functionality described above relative to FIG. 10 that occurs on individual smart phones can be accomplished on the cloud by interactive participation component 1008(6). The interactive participation component 1008(6) can operate cooperatively with the interactive participation component 1008(5) on the notebook computer to generate the second portion 116 of display 106 (see FIG. 1). The interactive participation components on the smart phones can be manifest as web clients relative to interactive participation component 1008(6).

One technique for accomplishing an interactive participation session can entail a user (e.g., presenter) engaging a graphical user interface (GUI) generated on notebook computer 104 by interactive participation component 1008(5). The user can request an interactive participation session on the GUI. The interactive participation component 1008(5) can cause the interactive participation session request to be sent to interactive participation component 1008(6) on the cloud. Interactive participation component 1008(6) can generate an interactive participation session and a mechanism to log into (e.g., register with) the session. For example, the mechanism can be a URI or a code such as a QR code (this aspect is described in more detail above relative to FIG. 1).

Interactive participation component 1008(6) can send the log-in mechanism back to notebook computer 104. The notebook computer's interactive participation component 1008(4) can cause the log-in mechanism to be displayed on display 106 (and/or otherwise made available to attendees). Any attendees can utilize the log-in mechanism to join the interactive participation session via their smart phone (e.g., smart phones 102(1), 102(2), and 102(3)). Notebook computer 104 may also provide another log-in mechanism or a derivation thereof to the presenter so that the presenter's smart phone 102(4) is distinguished by interactive participation component 1008(6) as the presenter's smart phone as opposed to the audience members' smart phones. Once the session begins, interactive participation component 1008(6) can obtain feedback from audience members' smart phones, aggregate the feedback and/or otherwise process the feedback as participation data to generate the features described relative to second portion 116 of the display described relative to FIGS. 1-6.

Similarly, the implementation described relative to FIGS. 7-9 can be accomplished with a device-centric approach as described relative to FIG. 10, a cloud-centric approach as described relative to FIG. 11, or with other approaches.

In summary, at least some of the implementations described above can provide an end-to-end, real-time interactive presentation feedback system. Some implementations can include a shared visualization of audience feedback, projected alongside the (presenter's or presented) content. This can be accomplished on the same display device or a different display device. This visualization can allow the audience and the speaker to take the collective temperature of the audience at any given time during a presentation of the content. The displayed feedback can be ambient and complementary to, rather than in competition with, the presentation content.

The present concepts can leverage the detection of interesting feedback events. In light of the description above relative to FIGS. 1-11, one implementation is summarized below. This implementation can detect the interesting events and provide speaker and participant notification when the interesting events happen. Interesting feedback events can be identified based on the type, quantity, and speed of participant activity, both individually and as a group. Group notification can be performed via a “badge” that is displayed visually on the sidebar, among other ways. Individual notification can be provided on individual devices, and speaker notification can occur on the presenter's phone. The presenter's notification can be accompanied by a sensory event, such as a vibration of the presenter's phone to draw the presenter's attention to the notification.

Some versions can include several components: a mobile client for providing feedback, a server component that collects the feedback, a shared visualization of the feedback, badges designed to include the speaker in the feedback, and a post-meeting summary of the feedback. One implementation of each these components is discussed in greater detail below.

Feedback Mobile Client

Meeting attendees provide feedback by visiting a webpage or by installing a feedback mobile phone application. For the webpage, the attendee is uniquely identified with a cookie. For the application, the attendee is uniquely identified with a user ID. (The application may also gather additional information about the participant such as gender, job role, or other recorded signals including geographic location, mobile operator, IP address, etc.). The webpage can exist to encourage early adoption, while the application provides a richer user experience. All experiences can be optimized for the mobile phone, pad-type device, etc. Audience members can provide positive feedback using a green thumbs up button, and negative feedback using a red thumbs down button. Other types of feedback could be provided, including, go faster, go slower, “identify me in the shared visualization,” or specific speaker-identified responses intended to elicit specific audience responses (e.g., polling, voting, or survey questions). In addition to button presses, gestures could be used to provide feedback.

Feedback Server

A server component can collect feedback from participants and display the feedback to the group. The server component may also record the audio or video from the meeting. Feedback and associated signals can be stored in a retrieval system, such as a database.

Feedback Sidebar

Feedback can be displayed to the audience members in a shared sidebar representation. Each “vote” on the client can correspond to a “light” on the sidebar, and changes to a color representing the feedback provided. Other visual features, such as shape, could be used to represent different types of feedback. The feedback can fade back to neutral over time.

The sidebar can be a stand-alone executable. When a slide presentation uses a specially designed template, the active sidebar can be positioned to float above a blank region on the template so that it appears immediately adjacent to the slide content. The sidebar could also be shown on its own, separately from a slide deck, either projected individually or shown on specialized hardware. It could also be built directly into a slide projecting application like PowerPoint® or other presentation software.

Badges and Speaker Notification

Badges can be triggered by certain individual behaviors, group behaviors or participation milestones, including those related to the type, quantity, quality, and timing of the feedback provided (e.g., participation data). Particular badges can be queued to appear by the speaker (e.g., in a “voting” scenario). The speaker's phone can buzz (e.g., vibrate) when a badge is triggered. Audience member phones may also vibrate. Badges could alternatively or additionally be represented in an auditory manner (e.g., as an audio message).

Post-Meeting Analysis of Feedback

After a meeting, users are able to view a summary of the participant feedback over time. Users can analyze feedback and signals recorded to determine “interesting moments,” or have such moments automatically identified for them. Interesting moments are synchronized in time (e.g., correlated) with the audio and video. A user can then replay only the time regions surrounding moments of interest. Feedback provided by subsets of participants (e.g., by demographics or job role) can also be viewed. Other methods of summarization such as transcription can be used to summarize interesting moments. Alternative and/or additional implementations are described above and below.

### Method Examples

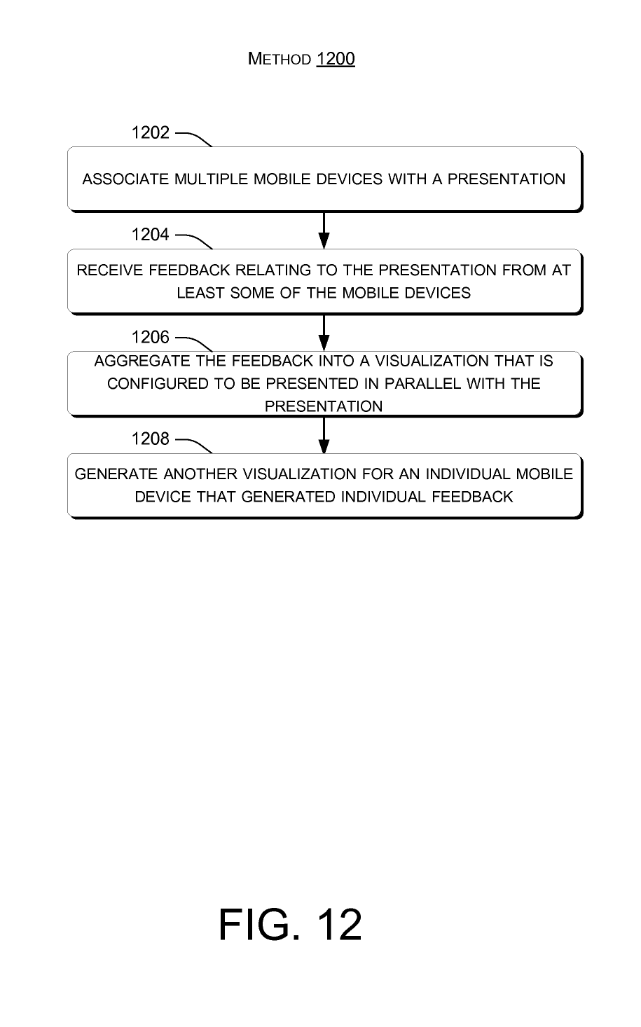

FIG. 12 illustrates a flowchart of a method or technique 1200 that is consistent with at least some implementations of the present concepts.

At block 1202, the method can associate multiple mobile devices with a presentation.

At block 1204, the method can receive feedback relating to the presentation from at least some of the mobile devices.

At block 1206, the method can aggregate the feedback into a visualization that is configured to be presented in parallel with the presentation. In one example, this visualization can be visible to all of the audience members and the presenter.

At block 1208, the method can generate another visualization for an individual mobile device that generated individual feedback. In one implementation, this another visualization is a badge that is displayed only on an individual mobile device of a recipient. The recipient may be an individual audience member or the presenter. Thus, this implementation can provide a summary of the feedback to everyone and individualized feedback for certain participants.

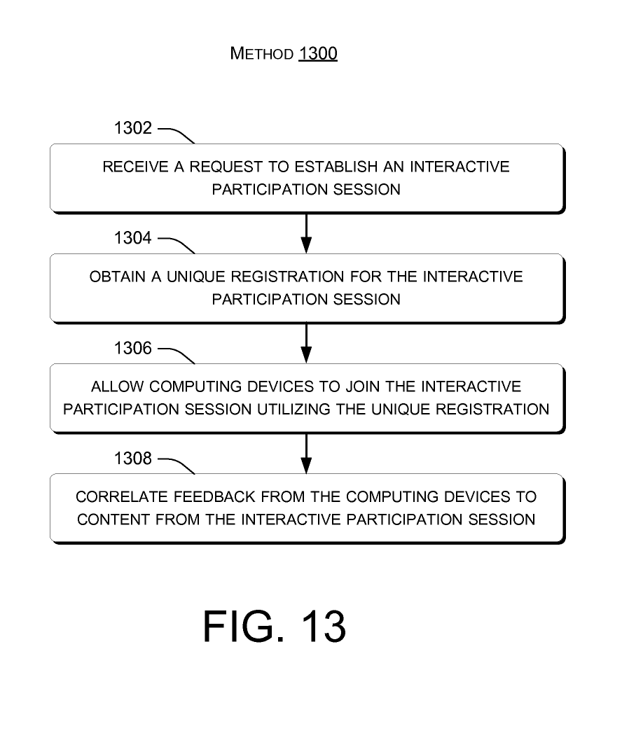

FIG. 13 illustrates a flowchart of another method or technique 1300 that is consistent with at least some implementations of the present concepts.

At block 1302, the method can receive a request to establish an interactive participation session.

At block 1304, the method can obtain a unique registration for the interactive participation session. Various examples are described above, such as QR codes and URLs, among others. In another example, the users could go to a web page that supports interactive participation sessions generally and then utilize a unique ID or registration that is specific to an individual interactive participation session.

At block 1306, the method can allow computing devices to join the interactive participation session utilizing the unique registration.

At block 1308, the method can correlate feedback from the computing devices to content from the interactive participation session. In this case, correlating feedback can be thought of as identifying a relationship between the feedback and the session, the relationship can be temporally based and/or content based, among others.

The methods can be performed by any of the computing devices described above and/or by other computing devices. The order in which the above methods are described is not intended to be construed as a limitation, and any number of the described blocks can be combined in any order to implement the method, or an alternate method. Furthermore, the method can be implemented in any suitable hardware, software, firmware, or combination thereof, such that a computing device can implement the method (e.g., computer-implemented method). In one case, the method is stored on a computer-readable storage media as a set of instructions such that execution by a computing device causes the computing device to perform the method.

### CONCLUSION

Although techniques, methods, devices, systems, etc., pertaining to real-time interactive participation implementations are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. One or more computer-readable storage media having instructions stored thereon that when executed by a processor of a computing device cause the computing device to perform acts, comprising:
associating multiple mobile devices with a presentation;
receiving feedback relating to the presentation from at least some of the mobile devices;
aggregating the feedback into a visualization that is configured to be presented in parallel with the presentation; and,
generating another visualization for an individual mobile device that generated individual feedback.

2. The one or more computer-readable storage media of claim 1, wherein the aggregating comprises aggregating the feedback into the visualization that is configured to be presented on a same device as the presentation.

3. The one or more computer-readable storage media of claim 1, wherein the associating comprises receiving a QR code from each of the multiple mobile devices.

4. The one or more computer-readable storage media of claim 1, wherein the feedback is aggregated in the form of a badge and shown in parallel to the presentation or in another visualization.

5. The one or more computer-readable storage media of claim 1, further comprising generating a third visualization for an individual mobile device that belongs to a user making the presentation.

6. The one or more computer-readable storage media of claim 5, wherein the third visualization comprises a badge that summarizes the feedback at a point in the presentation.

7. A computer-implemented method, comprising:
receiving a request to establish an interactive participation session;
obtaining a unique registration for the interactive participation session;
allowing computing devices to join the interactive participation session utilizing the unique registration; and,
correlating feedback from the computing devices to content from the interactive participation session.

8. The computer-implemented method of claim 7, wherein the obtaining comprises generating a code that includes a link to the interactive participation session.

9. The computer-implemented method of claim 7, wherein the allowing comprises registering individual computing devices generating a graphical user interface that includes a representation of each of the computing devices and uniquely identifying each individual computing device on the representation.

10. The computer-implemented method of claim 7, further comprising sending participation data to an individual computing device that provided at least some of the feedback.

11. The computer-implemented method of claim 10, wherein the participation data comprises a badge or an audio message.

12. The computer-implemented method of claim 7, further comprising aggregating the feedback, formatting the aggregated feedback for concurrent display with the content from the interactive participation session.

13. The computer-implemented method of claim 12, wherein the correlating comprises associating time stamps with the aggregated feedback that correlates the aggregated feedback with a particular temporal instance of the content.

14. The computer-implemented method of claim 7, further comprising generating a graphical user interface that includes a first portion that displays the content and a second portion that displays the feedback or wherein the interactive participation session is at least part auditory and further comprising presenting the correlated feedback in an auditory or tactile manner.

15. The computer-implemented method of claim 7, wherein the request is received from a first device that is configured to display the content and further comprising sending the correlated feedback to a second device that is separate from the first device.

16. The computer-implemented method of claim 7, further comprising analyzing the correlated feedback to generate a summary of the correlated feedback and sending the summary to a computing device of a presenter of the content during the interactive participation session.

17. The computer-implemented of claim 16, wherein the summary comprises a badge.

18. A system, comprising:
a processor and storage; and,
an interactive participation component stored on the storage for execution by the processor and configured to receive audience feedback during a presentation and to aggregate the feedback and send a summary of the aggregated feedback to a first device for display concurrent with the presentation and send the summary to a presenter's computing device during the presentation.

19. The system of claim 18, wherein the interactive participation component is further configured to generate a unique registration for the presentation and to log in individual computing devices that utilize the unique registration to participate in the presentation.

20. The system of claim 18, embodied as a notebook computer or embodied in cloud-based resources.
